(19) United States
(12) Patent Application Publication
(10) Pub. No.: US 2007/0211460 A1
(43) Pub. Date: Sep. 13, 2007

(54) Multi-color LED light source for microscope illumination

(76) Inventor: Ilya Ravkin, Palo Alto, CA (US)

Correspondence Address: ILYA RAVKIN, 945 Colorado Ave., Palo Alto, CA, 94303, US

(21) Appl. No.: 11/714,673

(22) Filed: Mar. 6, 2007

Related U.S. Application Data
(60) Provisional application No. 60/780,659, filed on Mar. 9, 2006.

(51) Int. Cl. F21V 9/00

(52) U.S. Cl. 362/231

(57) ABSTRACT

The invention provides a multicolor LED light source for transmitted light illumination compatible with most microscopes. The light source provides spatially and angularly uniform monochromatic illumination in red, green, or blue color, or in their combinations. Switching of wavelengths is very fast, which is desirable for automated scanning of specimens. The light source is inexpensive and compact; it can be accommodated in the condenser space of a typical microscope, eliminating standard white light source, condenser and light filtering device. The invention also provides different means of shaping light for illumination of microscopic specimens. The invention also provides a method for acquiring full color images with the present light source and a monochrome camera.

### CROSS-REFERENCE TO RELATED APPLICATIONS

This application claims the benefit of PPA Ser. Nr. 60/780,659 filed on Mar. 9, 2006 by the present inventor.

### FEDERALLY SPONSORED RESEARCH

Not Applicable

### SEQUENCE LISTING OR PROGRAM

Not Applicable

### BACKGROUND OF THE INVENTION

1. Field of the Invention

The invention relates to methods of illuminating a specimen in microscopy. In particular it relates to methods of illumination used for automated image acquisition.

2. Description of the related prior art

### LED Light sources

Light-emitting diodes are finding increasing acceptance in microscope illumination. LEDs and illuminators based on them possess some desirable qualities: small size, low power consumption, instant switching, long life, no moving, replaceable or serviceable parts. They also have some qualities that may limit their use: discrete spectrum which can not be “tuned” to a desired wavelength, low light intensity, requirement for special electronic drivers.

Prior art has several examples of microscope illuminators based on LEDs. The relevant art will be discussed here from the point of view of the present invention, which is to provide a compact and inexpensive multicolor light source primarily for transmitted light illumination, compatible with and retrofittable to most upright microscopes.

U.S. Pat. No. 4,852,985 discloses a microscope illuminating device having a surface light source with a number of discrete LEDs arranged in circles around the center LED, which is aligned on the optical axis, an optical system for condensing and transmitting the light emitted from the light source, and a control circuit for lighting some or all of the LEDs. The patent mentions that some of the LEDs of the surface light source may be of different colors and may be controlled independently; however the preferred embodiment for multicolor illumination is an arrangement of three surface light sources, each emitting light of different wavelength, which are optically combined into the same optical path. The disadvantage of the devices described in the patent is its size and complexity. In addition, in case of using LEDs of different colors in the same surface light source, the disadvantage is the non-identical pattern of light generated by discrete LEDs of different colors.

In U.S. Pat. No. 6,369,939 the motivation is to reduce thermal load by more efficient use of light. This is achieved by the use of two discrete LEDs. The first LED is placed in the focal point of the collector lens and the second is placed in a bore made in the collector lens. This arrangement is claimed to provide Koehler illumination with a single condenser for both low magnification and high magnification objectives. The disadvantage of this illumination system is the need to manufacture a special lens with a hole. In addition, a single LED may not provide enough light for fast imaging of a specimen.

Patent application 20030230728 describes a transilluminator for macro imaging of fluorescence containing discrete LEDs, which may be of different colors. The disadvantage of this invention is its large size; it cannot be used in restricted space available for a microscope illuminator. In addition, the light pattern of different colors may be different.

U.S. Pat. Nos. 6,674,575 and 6,795,239 describe a transmitted-light illuminator with two LEDs, one facing in the direction of the specimen and one facing in the opposite direction, where the light of the second LED is deflected in the illumination direction by deflecting mirror. The disadvantage of this invention is that it would be difficult to provide uniform multicolor illumination with this type of arrangement, since it relies on the light emitter being on the optical axis of the microscope. In addition, the apparatus of the invention is fairly complex, having mirrors and lenses, which must be accurately aligned.

Patent application 20040027658 describes a battery-powered microscope with white-light LED illuminator. The LED is positioned on the optical axis below the collector lens. No means are provided for multicolor illumination.

Patent application WO 2004/086117 describes a rotating assembly of LEDs of different wavelengths which can be positioned in the illumination beam path of the microscope. The disadvantage of this invention is slow switching, large size and complexity of the device.

Patent application 20050224692 describes a microscope having discrete light-emitting diodes with different emission wavelengths and an optical wavelength multiplexing device, which combines light emitted by these light-emitting diodes. The LEDs are positioned on the optical axes of the corresponding wavelength multiplexing assemblies. The disadvantages of this invention are its large size, complexity and the limitation to use one LED per color.

Patent application 20050225851 describes an LED-based transmitted light illuminating device for stereomicroscopy capable of providing bright field and dark field illumination. Dark field and oblique illumination are achieved by independently controlling the on-off state and brightness of groups of LEDs forming annuli and sectors. The disadvantages of this invention are that no provision is given for multicolor illumination and the large size of the device.

Patent application 20060291042 describes a custom imaging system wherein the illumination part consists of a uniform light source including LEDs, a diffuser, an array of beam collimating optics and a beam splitter. The application also mentions an LED array of different emitters with wavelengths from 250 nm to 1000 nm. No details of array construction are provided. The illuminating system is quite complex and large and can not fit in the small condenser space of a typical microscope.

Patent application 20070014000 is directed to true-color image reproduction in an automated microscope, which is identical to the visual perception of an optical eyepiece image. The application mentions an illumination field comprising individual semiconductor components, which emit in different wavelengths, but no details are provided.

### Light Diffusing

It is also an object of the present invention to provide means for shaping the light emitted by the light source. Traditional methods known in microscopy (Koehler illumination, see “Microscopes: Basics and Beyond”, Volume 1, by M. Abramowitz, Olympus Optical Corp.) deal with creating uniformly lit field of view with a given range of angles of light rays illuminating the specimen. In this method the size of the field of view illuminated by the light source is controlled by the field diaphragm and the numerical aperture is controlled by the aperture diaphragm. This method requires complicated and expensive optics in addition to the source of light itself: collector lens, condenser and optionally additional components, such as mirrors and filters. Another disadvantage of Koehler illumination is the need to match condenser to the objective and a rather laborious procedure for focusing the condenser and for the adjusting of the field and aperture diaphragms. These actions require relatively high level of training of the microscopist and must be performed any time the objective is changed, which creates a major inconvenience when objectives are changed often. In practice most of the observations are performed with non-optimal setting of the illumination system.

It is also known from the prior art that light diffusers can be used instead or in addition to condensers used for Koehler illumination.

U.S. Pat. No. 5,734,498 discloses an illuminator for transmitted light microscopes comprising light-diffusing bodies that is used without a condenser with any available light source and creates uniform illumination for bright-field imaging. U.S. Pat. No. 6,661,574 discloses a similar illuminator for reflected light microscopes; the illuminator is shaped as a ring so that viewing is performed through the hole for dark-field imaging. A shortcoming of these two patents is the need for custom manufacturing of the light-diffusing material.

U.S. Pat. No. 6,963,445 discloses a light diffuser made of flashed opal glass that is used in conjunction with a standard microscope light source and condenser. A disadvantage of this patent is low efficiency.

A common shortcoming of the prior art on diffusers is their low efficiency. Only a small fraction of the incident light passes through the diffuser due to absorption and multiple scattering of light by microscopic bodies in the diffusers. In particular, transmission of the opal glass is less than 25%. This is especially detrimental if the illuminator is to be used for fluorescence.

U.S. Pat. No. 5,822,053 recognizes the problem of low efficiency of common diffusers and describes a more efficient diffuser. This diffuser however is based on the same phenomenon of light scattering and achieves higher transmission at the expense of less homogeneous lighting, which is compensated for by specific design of the illuminator. A disadvantage of this patent therefore is not enough homogeneity of provided illumination.

Other shortcomings of diffusers known in the prior art are: (a) their inability to control directionality of light, (b) the degree to which the light is diffused, and (c) inability to create patterns of light, which may be beneficial for extracting certain phase information from specimens.

Another method of creating diffuse illumination for microscopes known in the prior art is the use of integrating spheres described in application 20050259437 and integrating cylinders described in U.S. Pat. No. 6,969,843. These methods share the same disadvantages of low efficiency and inflexibility as the diffusers mentioned above. In addition, they take up considerable space, which makes them difficult to use in the space available for condensers in upright microscopes.

### SUMMARY OF THE INVENTION

It is the object of this invention to provide a compact multicolor light source for transmitted light illumination compatible with most microscopes.

In one aspect the present invention is directed to a microscope light source that provides spatially and angularly uniform monochromatic illumination in at least two wavelengths, where the wavelength could be changed by the operator or by computer. Preferably, the light source provides wavelengths suitable for forming a full color image by combining images acquired by a monochrome camera in some or all of the wavelengths of the light source. Also, preferably the light source is compact and can be accommodated in the condenser space of a typical microscope. Also, preferably the light source is inexpensive to manufacture and provides cost savings by eliminating standard white light source, condenser and light filtering device. Also, preferably the light source provides fast switching of wavelengths, which is required for automated scanning of specimens.

The present invention achieves these goals by using a planar LED array which contains one or more sets of LED chips emitting light in red, green, and blue spectral bands, where each set has chips of all colors. Preferably each set is located in the same reflector cup. Such arrangement of LED chips provides high density of generated light per area, high spatial uniformity and makes the patterns of light substantially equivalent in all colors.

In addition to the LED array, the apparatus of the present invention may include light shaping plate, housing, heat sink, mounting adapter plate, control unit and power supply.

In another aspect, the present invention is directed to shaping the light, which illuminates the specimen. A particularly important aspect of light shaping is light diffusion for uniform, isotropic, shadow-free illumination of specimens. Another aspect of light shaping is anisotropic illumination which may create in certain unstained specimens contrast related to their shape. The light-shaping means of the present invention are based on light scatter, refraction and total internal reflection as described below.

In another aspect, the present invention provides a method of acquiring a color image with a monochrome camera by sequentially switching on individual colors, acquiring monochrome images, and then rendering them as a full color image.

In another aspect, the present invention is directed to extracting phase information from the images of the specimen acquired with different light-shaping elements.

In yet another aspect the present invention provides for a microscope illuminator that does not require diffusers, such as an illuminator based on organic light-emitting diodes (OLEDs). These semiconductor devices are area sources, not point sources as LEDs and can be shaped and sized to emit light close to the specimen eliminating the need for further light diffusion. A multicolor light source can be produced by stacking OLED layers that emit different colors; these layers are by themselves transparent.

### ADVANTAGES OF THE INVENTION

Fast switching of colors under computer control (especially advantageous in scanning applications).
Bright, uniform and diffuse illumination of large specimen area.
Provides for the acquisition of color images from monochrome digital camera with full non-interpolated color at every pixel.
No vibration or noise.
Low radiated heat.
Sequential acquisition of colors makes possible the adjustment of focus position for each color.
Provides improved image quality due to monochromatic illumination; this reduces the effect of chromatic aberrations present in microscope objectives.
No extra components in the imaging path of the microscope ensure that there is no deterioration of image quality.
Fits into condenser space of upright microscopes.
Cost saving due to elimination of standard light source, condenser and filter changer.
Long life, no moving or serviceable parts.

### BRIEF DESCRIPTION OF THE DRAWINGS

FIG. 1 is a diagram of a typical microscope with substage condenser known in the prior art.

FIG. 2 is a diagram of a microscope with the Multicolor LED Illuminator of the present invention installed instead of condenser.

FIG. 3 is a cross-sectional view of the Multicolor LED Illuminator of the present invention.

FIG. 4 is a light ray diagram of the Multicolor LED Illuminator of the present invention with a light-scattering diffuser.

FIG. 5 is a light ray diagram of the Multicolor LED Illuminator of the present invention with a light-refracting diffuser.

FIG. 6 is a block diagram of the Multicolor LED Illuminator of the present invention with control unit and power supply.

FIG. 7 shows schematic of red, green and blue LED chips in Lamina RGB light engine used in the preferred embodiment.

FIG. 8 is a cross-sectional view of an alternative embodiment of the Multicolor LED Illuminator of the present invention. This embodiment is preferably used for fluorescence illumination or with inverted microscopes.

FIG. 9 is a cross-sectional view of an alternative embodiment of the Multicolor LED Illuminator of the present invention with woven diffuser or with a side-illuminated diffuser.

FIG. 10 shows the principle of operation of woven light diffuser.

FIG. 11 shows the principle of operation of abraided light diffuser.

FIG. 12 is a conceptual diagram of an alternative embodiment of the Multicolor LED Illuminator of the present invention. This embodiment is based on RGB organic light-emitting diodes.

FIG. 13 shows normalized intensity profiles as a function of angle for different types of diffusers.

FIG. 14 is a photograph of a package including the Multicolor LED Illuminator of the present invention, control unit, power supply and cables.

FIG. 15 is a photograph of the Multicolor LED Illuminator of the present invention installed in Olympus BX51 microscope.

### TERMS

110—Objective.
111—Specimen on a substrate, e.g. on a glass slide.
112—Stage.
113—Condenser.
114—Adjustment ring of the condenser aperture diaphragm.
115—Microscope body.
116—Knob controlling up-down move of the condenser holder.
117—Movable condenser holder (mount).
118—Knob for centering of the condenser.
119—Fixing screw of the condenser.
120—Coarse focusing knob of the microscope.
121—Fine focusing knob of the microscope.
122—Adjustment ring of the field diaphragm.
30—Multicolored LED Illuminator of the present invention.
31—Light-shaping (usually, diffusing) element.
32—Optional additional diffusing filter or neutral density filter.
33—Tube and filter holder.
34—Heat sink to dissipate heat produced by LEDs.
35—Mounting adapter for the substage condenser holder of the microscope.
36—Illuminator tube.
37—Material with high light reflection and diffusing properties.
38—Control unit.
39—Power supply.
40—Board with array of LEDs (light engine).
41—Red LED chip.
42—Green LED chip.
43—Blue LED chip.
44—Reflector cup with LED chips.
45—Angular light intensity distribution with opal glass, Lambertian (cosine) distribution.
46—Angular light intensity distribution with ground glass.
47—Angular light intensity distribution with holographic diffuser.
48—Custom engineered angular light intensity distribution.
50—Light ray.
51—Collimating lens or microlens array.
52—Fiber optic light guide with woven diffuser or any side-illuminated diffuser.
53—Red OLED layer.
54—Green OLED layer.
55—Blue OLED layer.

### DETAILED DESCRIPTION OF THE INVENTION

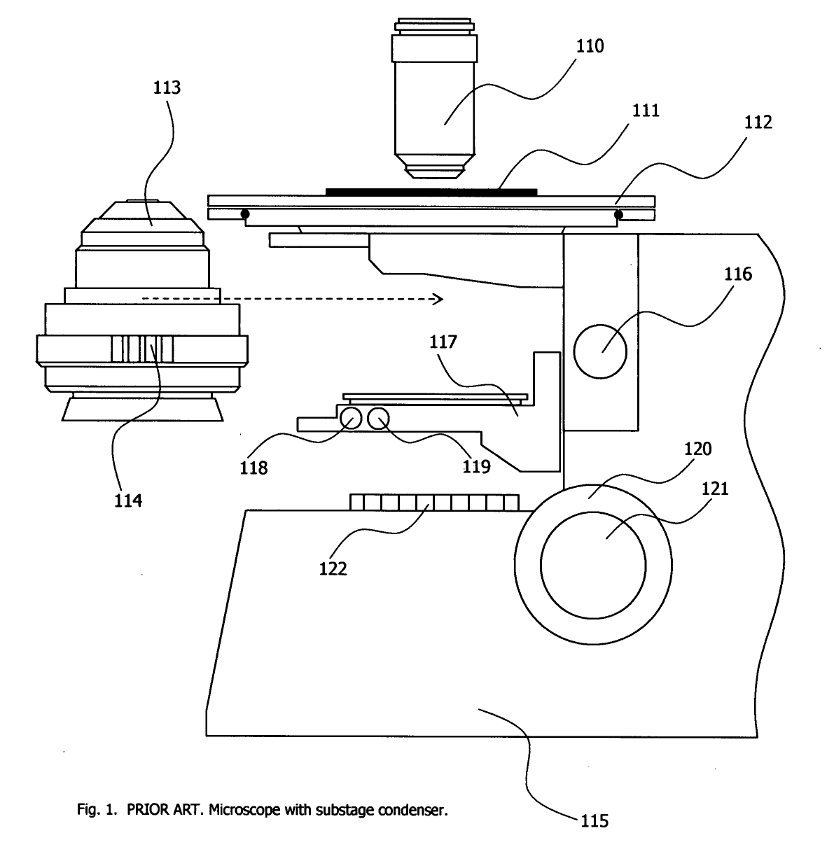

A diagram of the illuminating system of a typical microscope with substage condenser known in the prior art is shown in FIG. 1 (the light source is not shown). This configuration realizes Koehler illumination, which is explained in “Microscopes: Basics and Beyond”, Volume 1, by M. Abramowitz (http://micro.magnet.fsu.edu/primer/pdfs/basicsandbeyond.pdf). A detailed discussion of the practical application of this technique and the use of light diffusers to substitute for the optical components of Koehler illumination is given in the U.S. Pat. No. 5,734,498.

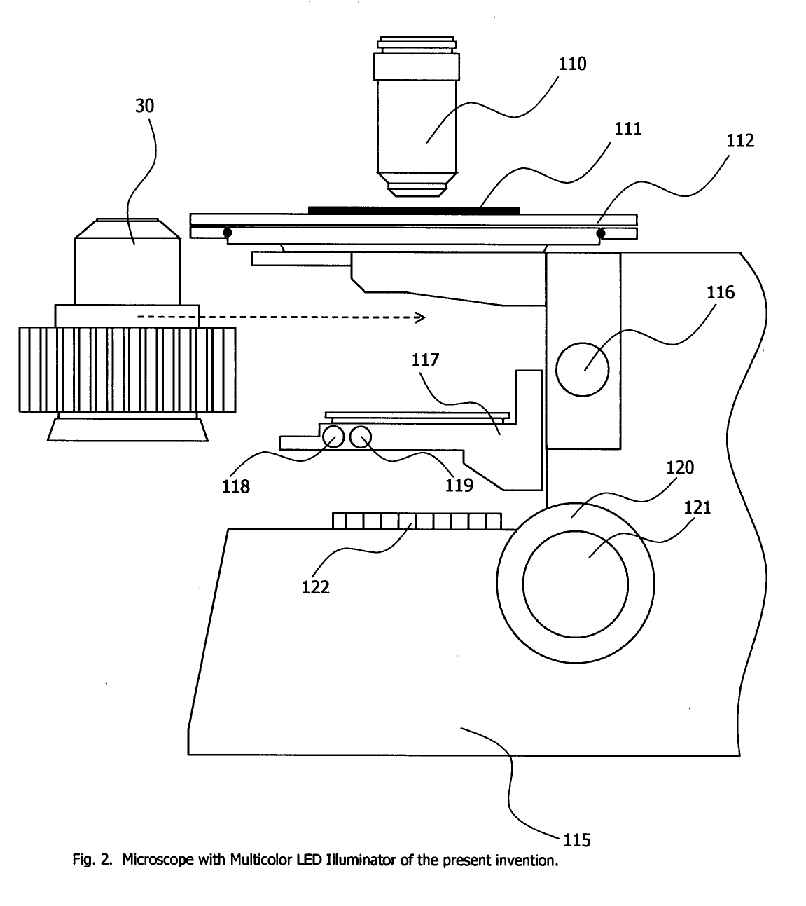

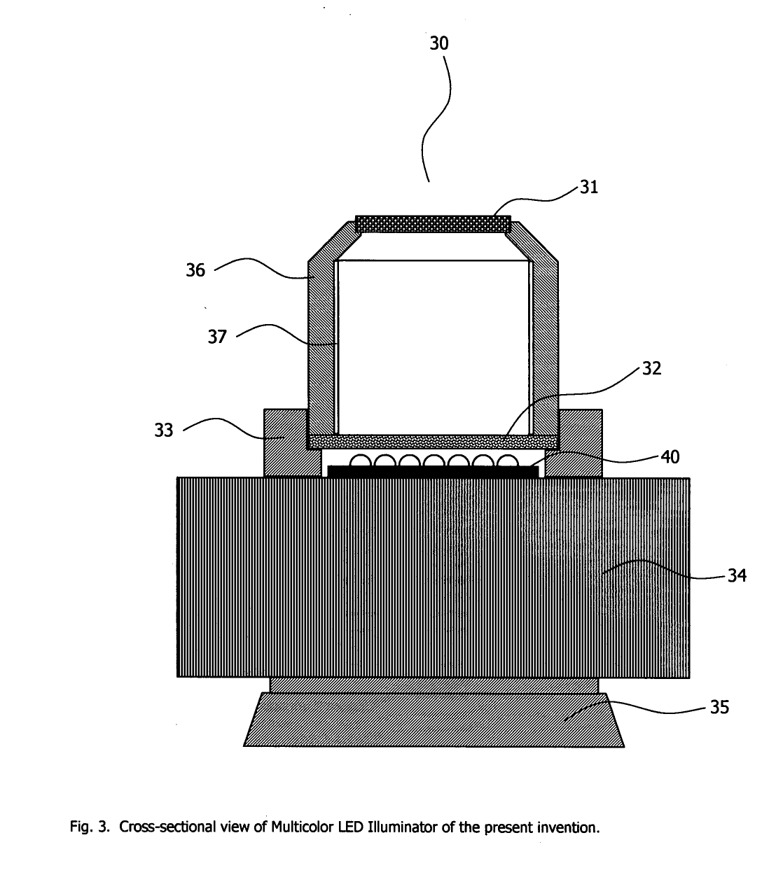

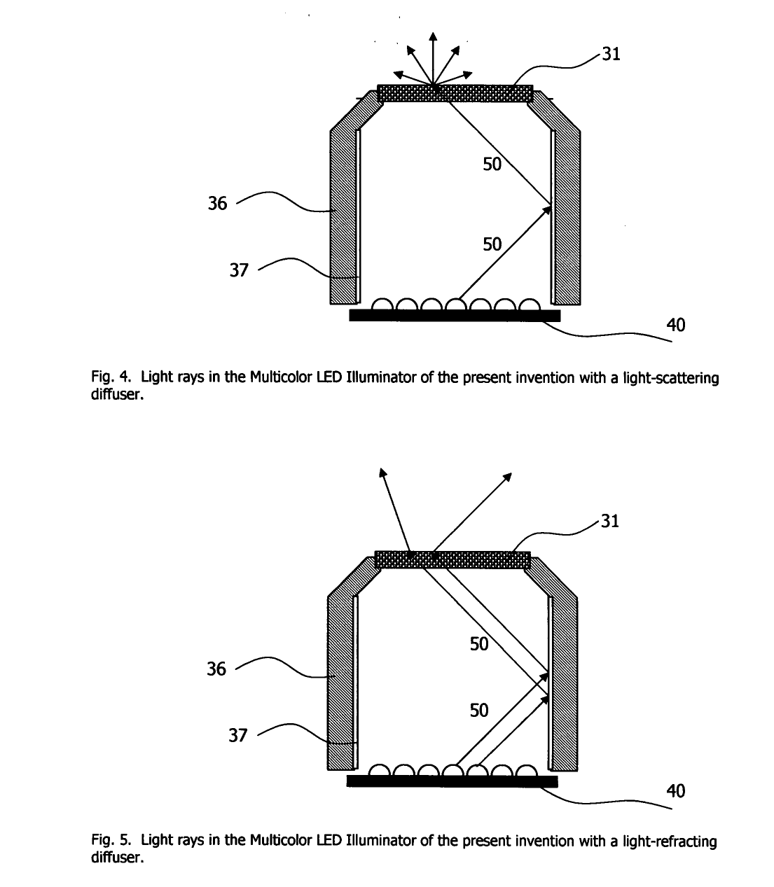

A diagram of a microscope with the Multicolor LED Illuminator of the present invention 30 installed instead of condenser 113 is shown in FIG. 2. The preferred embodiment of the Multicolor LED Illuminator of the present invention is shown in FIG. 3. The central element is the light engine 40, which is a board with an array of LED chips emitting light of different wavelengths. The heat produced by the LED chips is dissipated by a heat sink 34. The light emitted by LED chips passes through an optional filter 32, which can be a diffusing or a light-attenuating filter and reflects off the inside walls of the illuminator tube 36, which is covered by a light-diffusing material 37, as shown in FIGS. 4 and 5. The light-diffusing material can be a commonly available Zink Oxide or Titanium Oxide paints or Barium Sulfate coating (Kodak Diffuse Reflectance Coating, Kodak Co., Rochester, N.Y.; Munsell White Reflectance Coating, Edmund Industrial Optics, Barrington, N.J.). The illuminator tube 36 is connected to the heat sink 34 by means of tube holder 33. The Multicolor LED Illuminator 30 has a mounting adapter 35 for interfacing to the receptacle of the substage condenser. The mounting adapter may be microscope-specific.

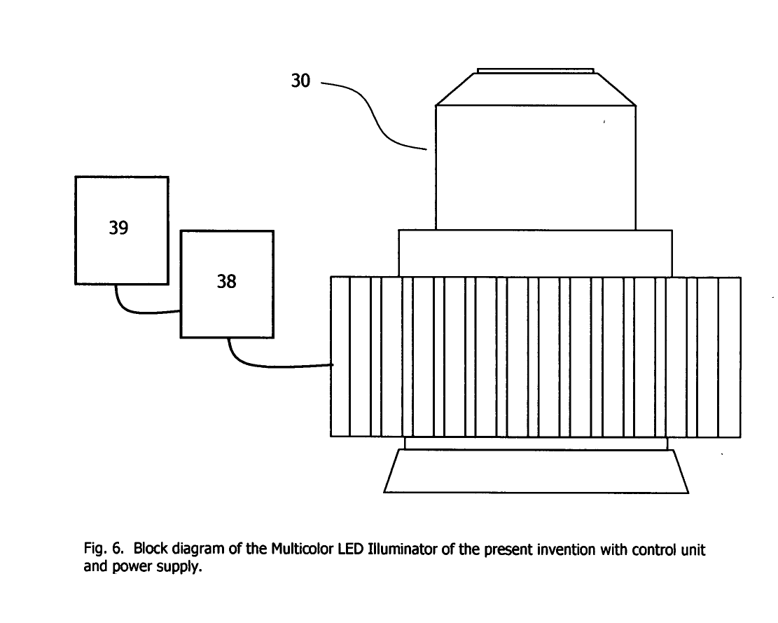

Additional devices needed to operate the Multicolor LED Illuminator of the present invention are shown in FIG. 6: the control unit 38 and the power supply 39. The control unit may be designed to accept logical on-off signals or communications commands using a computer interface, such as serial, USB, etc. The granularity of control should be at leas such that different colors could be controlled independently, in other words, all LED chips emitting light of the same color are controlled the same way. In addition, subsets of LED chips of the same color could be controlled independently. The control could be discrete (on-off) or continuous. Continuous intensity control could be implemented by changing the voltage or with pulse-width modulation (PWM).

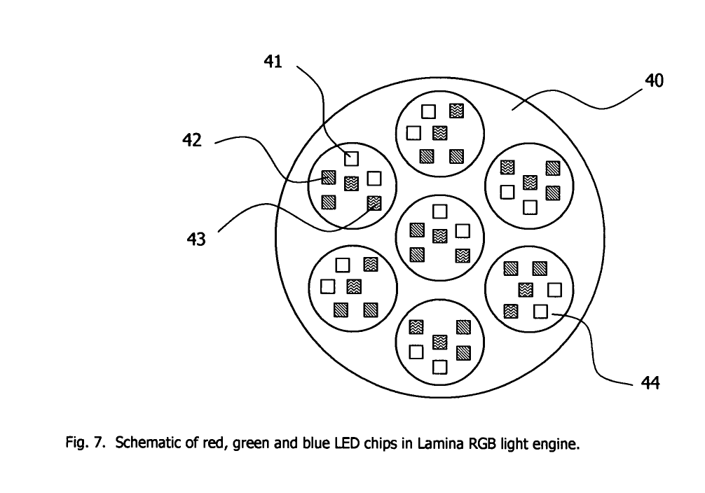

The light source of the preferred embodiment of the present invention is a planar LED array which contains one or more sets of LED chips emitting light in red, green, and blue spectral bands, where each set has chips of all colors. Preferably each set is located in the same reflector cup. Such arrangement of LED chips provides high density of generated light per area, high spatial uniformity and makes the patterns of light substantially equivalent in each of the colors since the chips of different colors are situated closely together. An example of such LED array 40 made by Lamina Ceramics (http://www.laminaceramics.com/products/b12000.aspx) is shown in FIG. 7. Light arrays of this and similar kind are available also from: PerkinElmer (http://optoelectronics.perkinelmer.com/content/datasheets/ACLLED.pdf), StockerYale (http://www.stockeryale.com/i/leds/intro.htm#overview), American Bright Optoelectronics (http://www.americanbrightled.com/3w.html), Ledtronics (http://www.ledtronics.com/ds/rgb1001/), Osram (http://catalog.osram-os.com/media/_en/Graphics/00033826_{—}0.pdf), Color Kinetics (http://colorkinetics.com/oem/dle/c102/), Enfis (http://www.enfis.com/products/ultra_high_spot.htm), OPTEK (Lednium series http://www.optekinc.com/led_pr1.asp), and others. Custom arrangements of LED chips can be ordered from e.g. Optrans America Corp. (http://www.optrans.com).

Light 50 reaches the light-shaping element 31 and is modified according to the nature of the element. FIG. 4 shows light scatter and FIG. 5 shows light refraction. For the purposes of this invention we can classify known light-shaping means into two categories: 1—front-illuminated based on refraction, scatter (diffusion), diffraction and their combinations, and 2—side-illuminated based on total internal reflection (including solid and fiber-based).

The best-known front-illuminated light shaping means are ground glass diffusers (http://www.edmundoptics.com/onlinecatalog/displayproduct.cfm?productID=1935&search=1) and opal glass diffusers (http://www.edmundoptics.com/onlinecatalog/displayproduct.cfm?productID=1671 &search=1). The level of diffusion in ground glass is chosen as a compromise with scatter loss. In opal glass the high level of diffusion causes a large amount of scattering loss. Opal glass can be used as a near-Lambertian source.

Other diffusers based on light scatter are EtherGlow (Tamar Technology, Newbury Park, Calif., www.tamartechnology.com/products.asp) and Zenith (SphereOptics, Contoocook, N.H., www.sphereoptics.com). A light-ray diagram for diffusers based on scatter is given in FIG. 4.

Another group of front-illuminated light-shaping elements is based on surface structures that direct incoming light rays into different directions as shown in FIG. 5. The surface structures are individually designed and distributed to enable desired beam shaping. Examples are Engineered Diffusers (RPC Photonics, Rochester, N.Y., http://www.rpcphotonics.com/engineer_diffuser.htm), Light Shaping Diffusers (Physical Optics Corporation, Torrance, Calif., http://www.poc.com/lsd/default.asp), Tailored Micro-Diffusers (WaveFront Technology, Paramount, Calif. http://www.wft.bz/micro3.htm)

These diffusers have the following advantageous features:
Specified divergence angles, from less than a degree to full hemisphere illumination
Specified angular intensity profiles
A particular spatial distribution of the illumination
High transmission efficiency around 90%
Achromatic performance

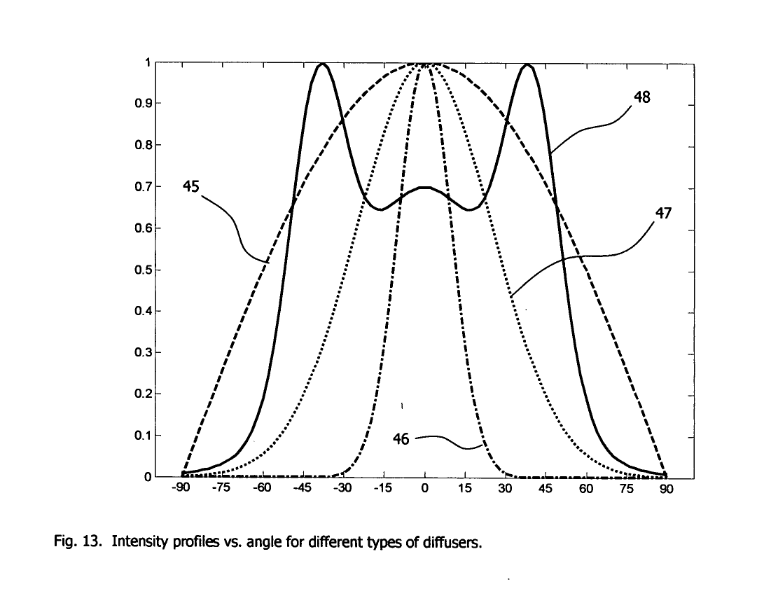

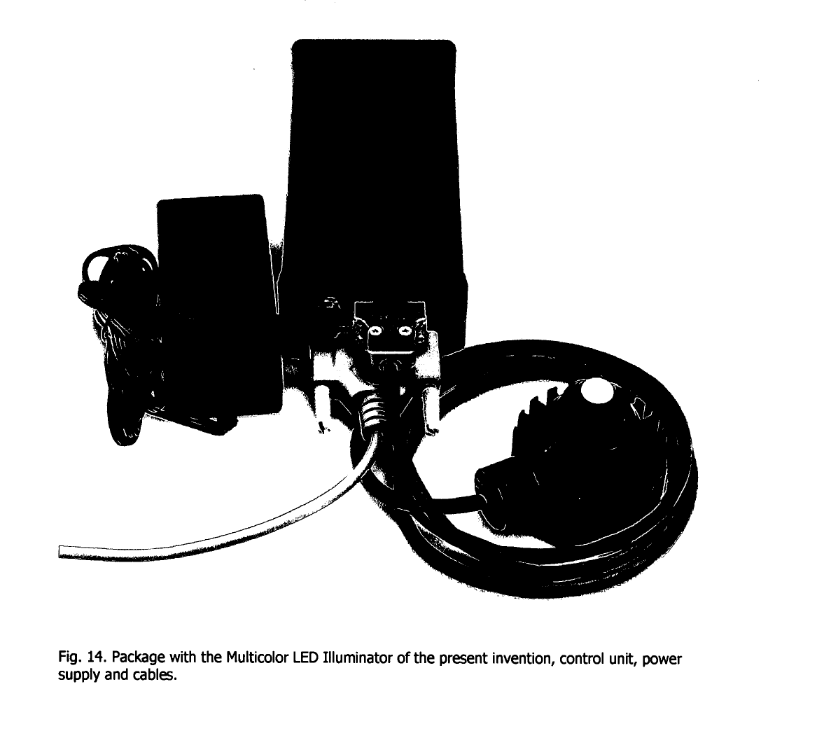

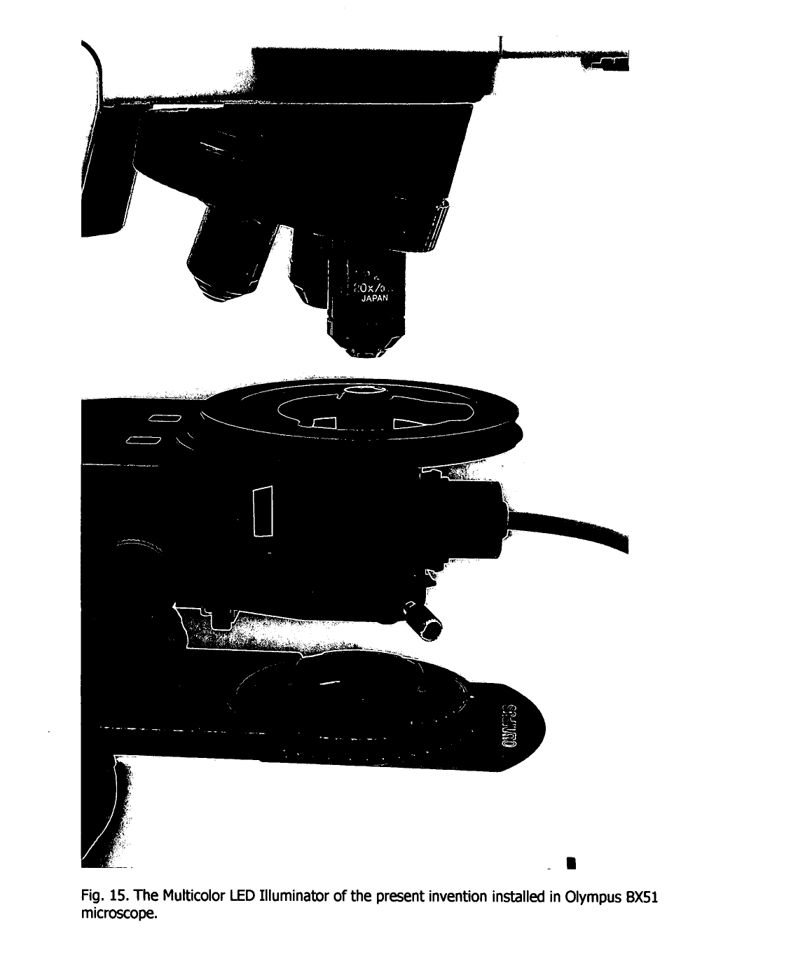

FIG. 13 shows normalized light intensity distributions as a function of angle for several types of diffusers.

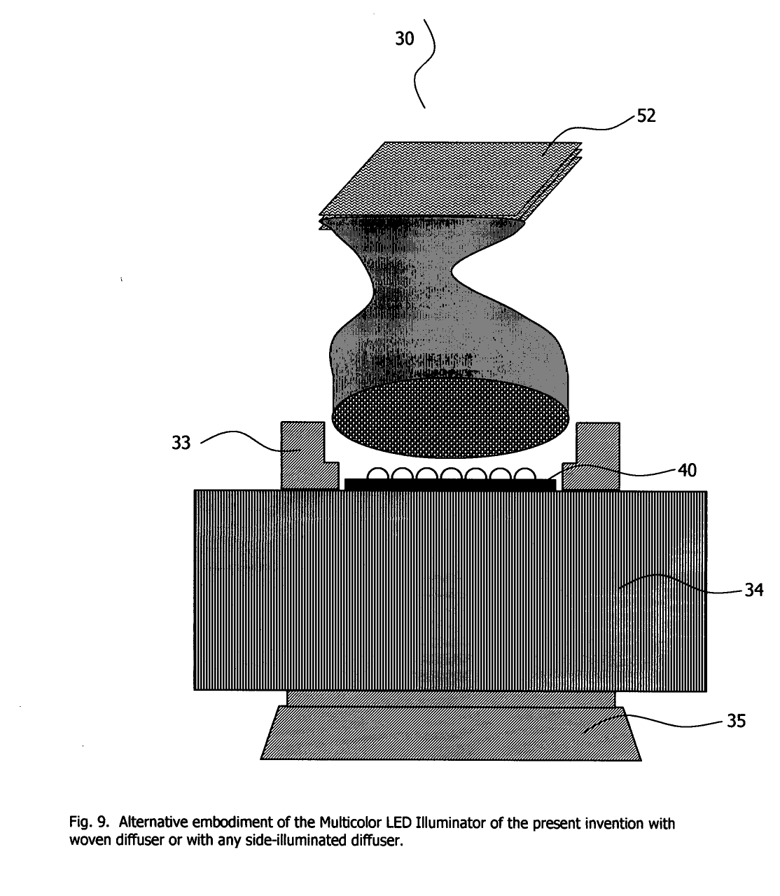

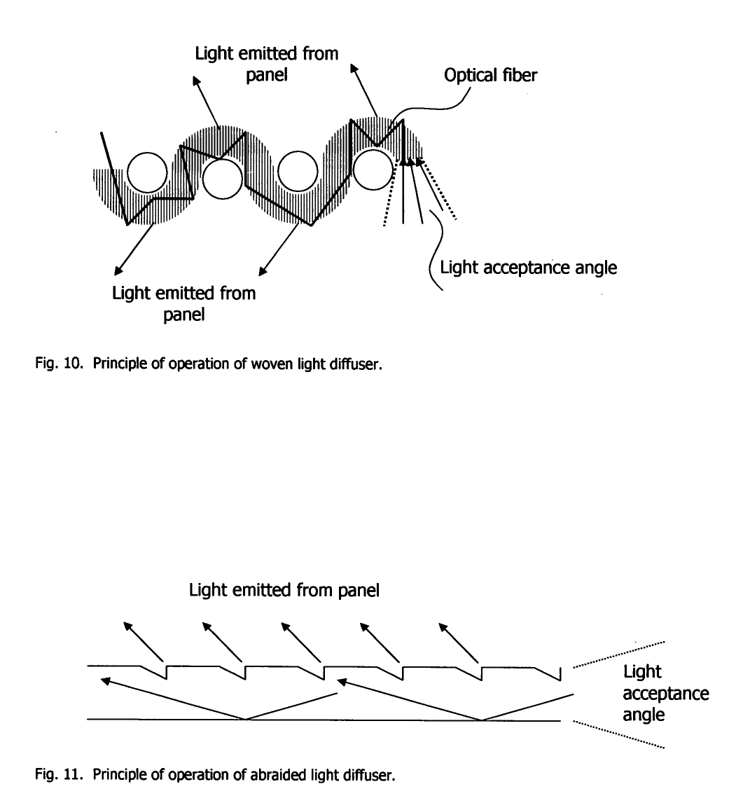

Examples of side-illuminated diffusers based on total internal reflection for passage of light inside the diffuser and on surface loss of light for illumination are Phlox (Leutron Vision, Burlington, Mass., http://www.leutron.com/us/) and woven and abraided light diffusers (Lumitex, Strongsville, Ohio). Phlox diffuser is a light pipe made from optical glass or PMMA (Plexiglas). The material surface is engraved by a laser with a deterministic pattern. When light is injected on a side of PHLOX light pipe, more than 90% of the light is reemitted on its surface. Diagram of the Lumitex woven diffuser (http://www.lumitex.com/Woven Technology.html) is given in FIG. 10. Diagram of the Lumitex UniGlo abraided diffuser is given in FIG. 11 (http://www.lumitex.com/UniGlo Technology.html). The Multicolor LED Illuminator of the present invention using the above-mentioned side-illuminated diffusers is shown in FIG. 9.

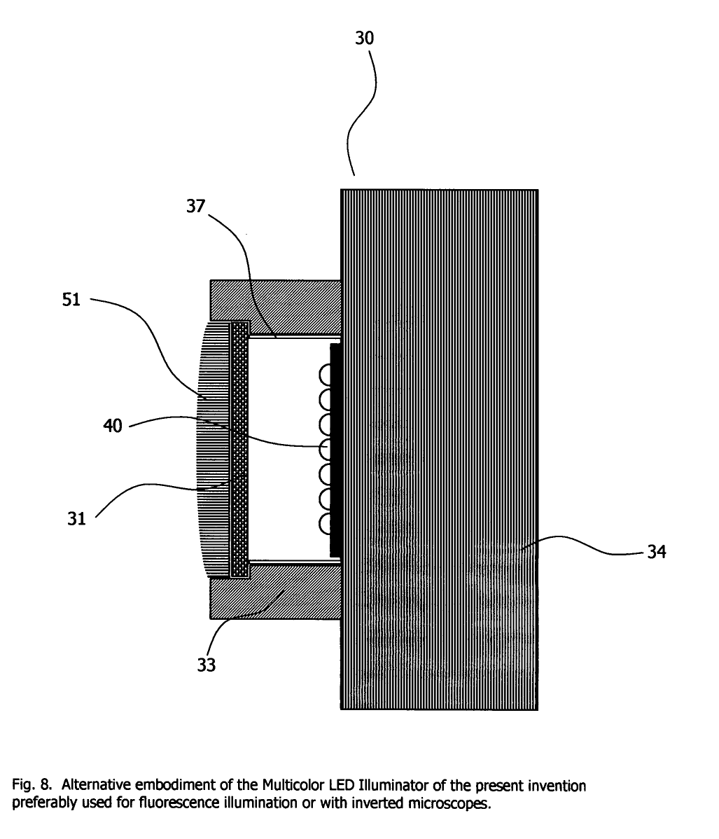

For use as a source of excitation light in fluorescent microscopes or as a source of transmitted light in inverted microscopes or in any other situation when the light-emitting surface is far from the specimen plane (or any plane conjugate with it) there is a need to collimate the illuminating light. To achieve this, a lens or a micro-lens array can be used as shown in FIG. 8. The light coming out of the diffuser surface 31 is highly divergent; it is partially collimated by a lens or microlens array 51.

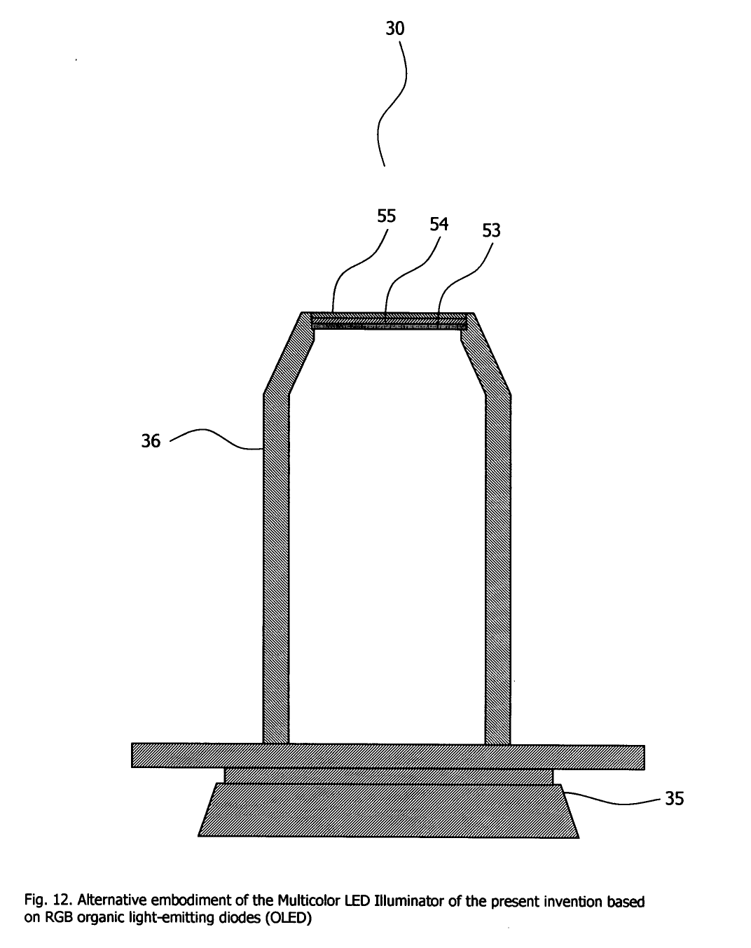

Alternative embodiment of the Multicolor LED Illuminator is based on Organic Light-Emitting Diodes (OLEDs) instead of LEDs. OLEDs are surface light sources as opposed to LEDs, which are point light sources. The substrate of OLED can be transparent and several layers, corresponding to different colors, can be stacked together as shown in FIG. 12 providing a multicolor surface light source with excellent uniformity.

In another aspect the present invention is directed to a method of color image acquisition using a monochrome image sensor (e.g., camera). Acquisition of monochrome images and their combination into a composite color image is common in fluorescence microscopy. There are two reasons for this: 1—filter sets for single excitation-emission pairs of wavelengths produce brighter signal than filter sets for multiple excitation-emission pairs of wavelengths, and 2—monochrome cameras are more light-sensitive than color cameras. In transmitted-light microscopy a typical solution is to use a white-light source and a color camera.

There are approaches known in the prior art where color filters have been used with a monochrome camera and white-light source to acquire color images in transmitted light. One example is MicroColor RGB tunable filter (Cambridge Research & Instrumentation, Inc. Woburn, Mass., http://www.cri-inc.com/files/MicroColor_Brochure.pdf). Alternatively a filter wheel with red, green and blue filters can be used for light filtering. Usually the filtering device is inserted in the imaging (emission) path of the microscope and sometimes it is built into the camera. A drawback of this approach is that since the filter is in the imaging path, the optical quality of the filter is critical for the quality of the resulting image. The method of the present invention eliminates extra components in the imaging path by moving wavelength selection to the light source. This ensures that the image quality will not suffer due to color filtering.

The present method of color image acquisition comprises the following steps: 1—switch the LED illuminator to the first desired color, 2—adjust the focus position of the specimen under the microscope, 3—acquire a monochrome image, repeat steps 1 to 3 for all desired wavelengths, 4-compose the acquired monochrome images into a (pseudo) color image. Step 2 is important because it compensates for the difference in the best focus position in different wavelengths of light. This difference is caused by chromatic aberrations in microscope optics and is objective- and wavelength-dependent.

In yet another aspect the present invention is directed to extracting phase information from images acquired with different diffusing means. A uniform wide-angle diffuser located closely to the specimen produces a shadow-free image of light absorption in the specimen. Diffusers that shape light with preferred directionality or with narrow angle produce images that combine absorption information and shape information of the specimen. In such case some light is refracted or scattered by the specimen and does not enter the objective, which results in shadows on the object boundaries. This information can be retrieved by subtracting images acquired with different appropriate diffusing elements or by applying other image processing procedures known in the art.

1. A light source for microscope illumination comprising:
(a) an array of LED chips capable of emitting light in at least two wavelengths and distributed on a surface so that emitted light of different wavelengths substantially coincides,
(b) a light-shaping element positioned at a certain distance from the array of LED chips,
(c) a housing containing the array of LED chips and the light-shaping element,
(d) means of controlling the on-off state and the intensity of LED chips emitting one wavelength of light independently from other LED chips.

2. The light source of claim 1, which is capable of being installed into condenser holder of an upright microscope.

3. The light source of claim 1 where the housing is moveably attached to the microscope and can be brought into close proximity to the specimen under observation.

4. The light source of claim 1 where the light-shaping element is a diffuser.

5. The light source of claim 1 where LED chips of different colors are positioned in the same reflector cup.

6. The light source of claim 1 where means of controlling LEDs have computer interface and can be controlled by a computer program.

7. The light source of claim 1 where the inside surface of the housing is covered with a material having high light-reflecting and high light-diffusing properties.

8. The light source of claim 1 where the LED chips emit light in generally the red, the green and the blue areas of spectrum.

9. A light-shaping element for use in illumination system of optical microscopes comprising:
(a) a light-shaping plate having two substantially parallel surfaces where at least one of these surfaces has been adapted to modify incident light creating a certain light pattern and
(b) a housing capable of positioning the light-shaping plate closely to the specimen under observation.

10. The light-shaping element of claim 9 where the light pattern is a substantially spatially isotropic distribution of light.

11. The light-shaping element of claim 9 where the angular light distribution follows a given intensity profile.

12. A light source for microscope illumination comprising:
(a) at least two layers of OLEDs emitting light of different wavelengths,
(b) a housing containing the layers of OLEDs,
(d) means of controlling the on-off state and the intensity of OLEDs emitting one wavelength of light independently from other OLEDs.

13. The light source of claim 12, which is capable of being installed into condenser holder of an upright microscope.

14. The light source of claim 12 where the housing is moveably attached to the microscope and can be brought into close proximity to the specimen under observation.

15. The light source of claim 12 where means of controlling OLEDs have computer interface and can be controlled by a computer program.

16. A method of acquisition of multicolor composite image through a microscope with a monochrome image sensor comprising:
(a) changing illumination means of the microscope to illuminate the specimen with light of a first wavelength
(b) adjusting position of the specimen relative to the microscope objective to bring the object in focus when illuminated with the first wavelength,
(c) acquiring the image of the specimen through the microscope with a monochrome sensor,
(d) repeating the steps (a), (b), and (c) for at least the second wavelength,
(e) combining the thus acquired monochrome images into a composite color image.

17. The method of claim 16 where illumination means is a multicolor LED illuminator.

18. A method of obtaining phase information from microscope specimens by performing a mathematical operation among images produced by illuminating the specimen with light passed through one of at least two different light-shaping elements.

19. The method of claim 18 where one of the light-shaping elements is a wide-angle diffuser.
